(19) United States
(12) Patent Application Publication
(10) Pub. No.: US 2021/0342787 A1
(43) Pub. Date: Nov. 4, 2021

(54) SYSTEM AND METHOD FOR MANAGING HUMAN RESOURCES ON A DECENTRALIZED RESOURCE NETWORK

(71) Applicant: Marlon Williams, Atlanta, GA (US)

(72) Inventor: Marlon Williams, Atlanta, GA (US)

(21) Appl. No.: 17/242,577

(22) Filed: Apr. 28, 2021

Related U.S. Application Data
(60) Provisional application No. 63/017,060, filed on Apr. 29, 2020.

(51) Int. Cl. G06Q 10/10; G06Q 10/06; G06Q 10/04; G06Q 50/18; G06F 16/27

(52) U.S. Cl. CPC G06Q 10/1053; G06Q 10/063118; G06Q 10/04; G06Q 20/367; G06Q 10/063112; G06F 16/27; G06Q 50/182

(57) ABSTRACT

A system and method for creating and for managing human resources over a decentralized human resources network is provided herein. The system has a plurality of nodes in a decentralized network in communication with one or more distributed ledgers capable of recoding data ledgers, each node having one or more processors and a memory, the memory being a non-transitory computer-readable medium having executable instructions encoded thereon, such that upon execution of the instructions, one or more nodes in the plurality of nodes perform operations of receive a resource definition associated with an agent of a plurality of agents, receive a request from the organization for a need for at least an agent of the plurality of agents, store the request on the one or more distributed ledgers, call a function located within the distributed ledger to ascertain whether the request from the organization matches the resource definition of the at least one agent of the plurality of agents, if there are no matches, store, on the distributed ledger an open request, continuously query the function until the request from organization matches one of the resource definitions associated with an agent of the plurality of agents, if there is a match, notify the agent and the organization, and issue a smart contract to the agent from the organization and store the contract in the distributed ledger.

### CROSS-REFERENCE TO RELATED APPLICATIONS

This application claims the benefit of U.S. Provisional Application Ser. No. 63/017,060 entitled System and Method for Creating a Decentralized Resource Network filed on Apr. 29, 2020, the entire contents of which are incorporated herein by reference for all purposes.

### FIELD OF THE INVENTION

The present invention relates generally to systems and business method for human resource providers to solicit additional resources over a decentralized network. More particularly, the present invention relates to certain new and useful advances in computer-based systems that can be used by companies and individuals alike to both advertise and solicit available human resource personnel for the performance of various human resource related tasks utilizing blockchain, where payment is also processed over the decentralized network through the use of cryptocurrency, reference being had to the drawings accompanying and forming a part of the same.

### BACKGROUND

The enterprise software licensing approach pioneered by Microsoft® has dominated the software industry for the past 30 years. Over time, this approach has evolved from single installations with no networking features to providing for networking between workbooks utilizing a centralized database across multiple client installations. As time progressed, the ability to provide networking support between workgroups using a centralized database was developed. Subsequently, numerous providers of business software added shared networking supporting into their applications, leading us into the client-server software model that dominated enterprise software during the 1990s.

However, enabled by the World Wide Web and pioneers in customer relationship management, enterprise software pivoted into the cloud-based model we use today, which supports multiple “workgroups” operating within a centralized, multi-tenant platform accessible to anyone with Internet access. Software vendors from all industry verticals—from healthcare, communications, and retail, to finance, non-profit and professional services—have since adopted the “cloud” as the de-facto deployment for their applications.

Yet, as with all developments in technology, the demand for cloud-based services bred innovation in other disciplines of technology. Specifically, in the data center realm where client-server applications previously resided, infrastructure-as-a-service (IaaS) providers allowed organizations of all sizes to build “virtual data centers” to run their applications at the click of a button. This largely transferred the responsibility of managing physical technology infrastructure from organizations that weren't technology service providers to vendors who specialized in IaaS. This delegation of responsibility allowed companies to focus on delivering services and solutions to solve business problems, increase their speed of innovation and find producer-market fit much faster. Despite these advancements, numerous resource sharing opportunities exist within the niche communities and ecosystems developed by vertical enterprise software.

Blockchain technology is an incorruptible digital ledger of economic transactions that can be programmed to record not just financial transactions but everything of value. Blockchain functions as a secure, public ledger of all transactions on a peer-to-peer network that cannot be tampered with except through the use of an impractically large amount of computing power. In fact, blockchain technology has been in use with the popular cryptocurrency, Bitcoin, since 2008 without any significant disruptions.

The backbone of blockchain technology is the idea of decentralization, which means that the network operates on a user-to-user (or peer-to-peer) basis. A blockchain network is comprised of various decentralized computers connected to the specific blockchain network, with each computer automatically downloading a copy of the blockchain when it joins the network. Each of these computers are referred to as “nodes” and together, they not only make up the blockchain but can also directly access (e.g., read and write) the blockchain database. Each node's copy of the ledger is identical to every other node's copy so that the set of copies can be referred to as a single blockchain distributed database—meaning the blockchain distributed database is replicated on all the nodes and not one central node or server. As such, a blockchain distributed database is a system in which there is no central administrator.

A blockchain distributed database is reliable and transparent, in that transactions are permanently recorded and cannot be revised. This means that data stored in it cannot be altered or deleted without leaving a trace. In exemplary embodiments, timestamps may be used for this purpose. These transactions are grouped into so-called blocks, which are, after validation via a consensus algorithm, chained together over time in a so-called blockchain. The blocks form a chain because each block contains a reference to the previous block—for example, each block contains a timestamp of when the previous block has been added to the chain.

The validity of a transaction may be verified in the consensus process by checking a digital signature of the transaction. Each node in the network may be associated with an identifier and provided with a cryptographic private-public key. All the nodes in the network may have a list of the public keys and the respective identifiers of the other nodes. When a node sends a transaction to the blockchain distributed database, it signs the transaction with its private key. The transaction may then be broadcast to the other nodes sharing the blockchain distributed database, wherein each communication from a node uses the node's identifier. One of the first and most notable applications of blockchain technology is with the use of cryptocurrency, namely, Bitcoin. By using a blockchain, there is no need for a decentralized system and as such, there is no need to pay an intermediary, thus saving you time and conflict.

While the cryptocurrency Bitcoin is most commonly associated with blockchain technology, its application goes way beyond this. In fact, Bitcoin is only one of several hundred applications that use blockchain technology today—one of the other applications is Ethereum, a distributed public blockchain network. Unlike Bitcoin, which offers only one application (e.g., a peer-to-peer electronic cash system that enables online Bitcoin payment), the Ethereum blockchain focuses on running the program code of any decentralized application. Thus, with Ethereum you can deploy a various slew of decentralized applications using the Ethereum Virtual Machine (EVM). This is important because this allows for other important advances in blockchain technology, such as the use of smart contracts, a computer protocol intended to facilitate, verify or enforce the negotiation or performance of a contract.

Expanding further, a blockchain may feature permissioned blockchain distributed database, a blockchain distributed database in which transaction processing is performed by nodes associated with known identities. By using a permissioned blockchain, nodes may stipulate to trusted agreements with the conditions of those agreements stored in the blockchain distributed database, and since they reside in the database, their conditions are transparent. This process is otherwise known as a smart contract, a protocol used to enforce provisions of a contract utilizing some degree of automation. For example, when using a smart contract in a blockchain distributed database, the nodes will check whether or not a required task has been performed in accordance with the agreed-upon provisions in the smart contract, and automatically send payments to the necessary party.

In the realm of human resources, one of the largest problems faced by companies is idle time. For example, in reference to call centers, an organization is often faced with paying hourly for representatives who sit idle for most of their time. According to Aberdeen, call center agents spend approximately 25% of their time in an idle state. In a standard 8-hour shift, this results in a loss of 2 hours per work day or 10 hours per 5-day work week simply due to idle time. With an agent pay rate of roughly $10.50 per hour, at a 100-agent contact center, this results in approximately $546,000 lost to idle time per year.

In the alternative, call centers may also run the problem of having insufficient staffing for peak seasons. During peak seasons, the volume of interactions spike and it becomes a hassle for a contact center to procure the necessary staff to handle the increased volume effectively. According to emarketer.com, US retail e-commerce sales increased by 17.8% during the 2016 holiday shopping season. An increase in sales typically means an increase in call volumes at contact centers as customers reach support for various purchase-related issues. This leaves contact centers with the challenge of efficient hiring and scheduling for a bust season, while attempting to minimize their customer abandonment rate.

A contact center typically begins a lengthy process to acquire the necessary staff. First, they have to analyze past years and predict the number of representatives needed during the peak season. For sophisticated contact center operations, this process is typically performed using advanced workforce management software while less sophisticated centers rely on manual entries from old Excel spreadsheets. Then, the contact center recruits staff utilizing either its own human resource department, or a recruiting/staffing agency. Should the contact center elect to hire an agent, it would need to provide information such as the total number of representatives required, language proficiency requirements, skillsets, experience requirements, background check requirements, a budget per representative and a desired schedule. After a cumbersome negotiation period, the staffing agency then sends potential recruits to the contact center, which then vets and trains the potential recruits according to its own practices.

As such, a need exists for a system and method for a decentralized human resource network that is able to manage large amounts of data whilst running the scripts faster and more efficiently for staffing decisions in an industry where demands are constantly fluctuating.

### SUMMARY OF THE INVENTION

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

To achieve the foregoing and other aspects and in accordance with the purpose of the invention, a system and method for managing human resources over a decentralized blockchain distributed network is presented. The system also creates the decentralized network.

Advantageously, the system allows companies to solicit and hire individuals to fill specific employment rolls.

Further, the present platform provides a system through which payment can be made through a decentralized network for the work performed by the individuals hired.

Further, the present platform is to provides forecasting methods to allow companies to analyze and project in advance their staffing needs.

Further, the present platform provides a means for training potential hires prior to hiring.

Further, the present platform utilizes blockchain to increase the efficiency and effectiveness of the system.

A system and method for creating and for managing and managing and disseminating human resources over a decentralized human resources network is provided herein. The system has a plurality of nodes in a decentralized network in communication with one or more distributed ledgers capable of recoding data ledgers, each node having one or more processors and a memory, the memory being a non-transitory computer-readable medium having executable instructions encoded thereon, such that upon execution of the instructions, one or more nodes in the plurality of nodes perform operations of receive a resource definition associated with an agent of a plurality of agents, receive a request from the organization for a need for at least an agent of the plurality of agents, store the request on the one or more distributed ledgers, call a function located within the distributed ledger to ascertain whether the request from the organization matches the resource definition of the at least one agent of the plurality of agents, if there are no matches, store, on the distributed ledger an open request, continuously query the function until the request from organization matches one of the resource definitions associated with an agent of the plurality of agents, if there is a match, notify the agent and the organization, and issue a smart contract to the agent from the organization and store the contract in the distributed ledger.

In another embodiment, a computer implemented method for consensus ordering of broadcast messages, the method comprising an act of causing one or more of a plurality of nodes in a network to execute instructions stored on a non-transitory computer readable medium, such that upon execution of the instructions, one or more nodes in the plurality of nodes perform operations of receiving a resource definition associated with an agent of a plurality of agents, receiving a request from the organization for a need for at least an agent of the plurality of agents, storing the request on the one or more distributed ledgers, calling a function located within the distributed ledger to ascertain whether the request from the organization matches the resource definition of the at least one agent of the plurality of agents, if there are no matches, storing, on the distributed ledger an open request, continuously querying the function until the request from organization matches one of the resource definitions associated with an agent of the plurality of agents, if there is a match, notifying the agent and the organization, issuing a smart contract to the agent from the organization and storing the contract in the distributed ledger.

In an embodiment, a system for managing and disseminating human resources on a decentralized human resources network. The system comprises a first client computer system, a second client computer system, and a resource server computer system, wherein both the server computer system are configured to communicate with a distributed blockchain computer system that includes multiple computing nodes, each computing node storing a copy, or a portion thereof, of a blockchain of the distributed blockchain computer system; wherein the resource server computer system comprises, a memory configured to store, a distributed ledger database comprising linked data block, wherein the distributed ledger configured to determine whether there is a match between a request for personnel from an organization, and a resource definition from an agent, a campaign generator configured to receive a plurality of inputs from the organization, and also receive information from a script generator to request the agent, wherein the organization is a call center.

In exemplary embodiments, using blockchain technology and smart contracts to create a decentralized human resources network is provided. The system and method has the ability to both list and view the availability of human resources for hire (e.g., how many call center operators are available for hire); it also collects and stores the data regarding such availability and needs to extrapolate needs and availability in the future (e.g., notifying a company that last year they needed ten more employees than they had planned for, or that they had overstaffed by ten more employees than what they actually needed); it allows for the acquisition of those human resources through the use of smart contracts and its own currency format; it also allows the purchasers of such human resources to set certain training requirements through the use of classes stored on the blockchain.

Other features, advantages, and aspects of the present platform will become more apparent and be more readily understood from the following detailed description, which should be read in conjunction with the accompanying drawings.

### BRIEF DESCRIPTION OF THE DRAWINGS

Features of the present disclosure are illustrated by way of example and not limited in the following Figure(s), in which like numerals indicate like elements, in which:

FIG. 1 illustrates a system diagram for a decentralized network based upon a distributed ledger (e.g., blockchain) used by an organization build campaigns and to locate and hire agents according to an embodiment of the present disclosure;

FIG. 2 illustrates a system diagram for a decentralized network based upon a blockchain used by an agent to locate and be hired by an organization according to an embodiment of the present disclosure;

FIG. 3 illustrates a networked system diagram for a decentralized network based upon a blockchain used by an organization and an agent according to an embodiment of the present disclosure;

FIG. 4 illustrates a network system diagram for a decentralized peer-to-peer network for providing communications to and from devices in accordance with one embodiment of the present platform;

FIG. 5 illustrates a network system diagram for a decentralized network based upon a blockchain distributed database and two sample communications or messages in accordance with one embodiment of the present platform;

FIG. 6 illustrates a stepwise method diagram depicting a method through which an in organization hires and pays for agents using a blockchain distributed database in accordance with one embodiment of the current platform in accordance with one embodiment of the present platform;

FIG. 7 illustrates a stepwise method depicting a method through which an agent finds an organization receives payment for the same using a blockchain distributed database in accordance with one embodiment of the current platform;

FIG. 8 illustrates a stepwise method diagram depicting a method through which an Organization builds and issues a Request for Personnel using a blockchain distributed database in accordance with one embodiment of the current platform;

FIG. 9 illustrates a hybrid system/stepwise method diagram depicting a method through which an agent builds and issues a resource definition using a blockchain distributed database in accordance with one embodiment of the current platform;

FIG. 10 illustrates an exemplary user interface for an organization in accordance with one embodiment of the present invention;

FIG. 11 illustrates an exemplary user interface for an agent in accordance with one embodiment of the present invention;

FIG. 12 illustrates another exemplary user interface for an organization in accordance with one embodiment of the present invention;

FIG. 13 illustrates another exemplary user interface for an organization in accordance with one embodiment of the present invention;

FIG. 14 illustrates another exemplary user interface for an agent in accordance with one embodiment of the present invention;

FIG. 15 illustrates another exemplary user interface for agent to chat with a customer in accordance with one embodiment of the present invention;

FIG. 16 illustrates another exemplary user interface for payments in accordance with one embodiment of the present invention; and

FIG. 17 illustrates another exemplary user interface for a call log in accordance with one embodiment of the present invention.

### DETAILED DESCRIPTION OF THE INVENTION

The present invention is best understood by reference to the detailed Figures and description set forth herein.

Embodiments of the invention are discussed below regarding the FIGS. However, those skilled in the art will readily appreciate that the detailed description given herein with respect to these Figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described are shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Those skilled in the art will recognize that this example is illustrative and not limiting and is provided purely for explanatory purposes. An example of a computing system environment is disclosed. The computing system environment is not intended to suggest any limitation as to the scope of use or functionality of the system and method described herein. Neither should the computing environment be interpreted as having any dependency or requirement relating to any one or combination of components illustrated in the exemplary operating environment.

Embodiments of the disclosure are operational with numerous other general purposes or special purpose computing system environments or configurations. The embodiments of the disclosure may be described in the general context of computer-executable instructions, such as program modules, being executed by a computer or smart device. Generally, program modules include routines, programs, objects, components, data structures, etc. that perform particular tasks or implement particular data types. The systems and methods described herein may also be practiced in distributed computing environments where tasks are performed by remote processing devices that are linked through or overlayed by a communications network. In a distributed computing environment, program modules may be located in both local and remote computer storage media including memory unit or storage devices. Tasks performed by the programs and modules are described below and with the aid of figures. Those skilled in the art can implement the exemplary embodiments as processor executable instructions, which can be written on any form of a computer readable media in a corresponding computing environment according to this disclosure.

Computers and smart devices may comprise a variety of computer readable media. Computer readable media can be any available media that can be accessed by computer and comprises both volatile and non-volatile media, removable and non-removable media. By way of example, and not limitation, computer readable media may include computer storage media and communication media. Computer storage media comprises both volatile and non-volatile, removable and non-removable media implemented in any method or technology for storage of information such as computer readable instructions, data structures, program modules or other data.

As used herein, the term “computer” or “user device” refers to any computing device that is used when a user requires a user interface (UI).

As used herein, the term “Agent” means any individual (e.g., independent contractors) or business (e.g., a call and contact center business process outsourcer) specializing in providing customer service (e.g., sales or support). Each Agent will be assigned a unique identification hash that will be used to verify all of their activity of the network.

As used herein, the term “blockchain distributed database” or “blockchain” means a database that is a distributed ledger and is shared among a plurality of nodes constituting a network, wherein each node can directly access (e.g., read and write) the database, and there is no central administration. Any references to the term “network” herein shall mean that decentralized network of the present invention that is operated through a blockchain distributed database, but may also be a centralized network, decentralized, or distributed.

As used herein, the term “course” shall mean courses that are offered specifically through the network.

As used herein, the term “device” shall mean any instrumentality or aggregate of instrumentalities operatable to compute, classify, process, transmit, receive, originate, switch, route, or utilize any form of information, intelligence, or data for business, scientific, control, entertainment, or other purposes. For example, a device can be a personal computer, a laptop computer, a smart phone, a tablet device, a network server, a network storage device, or any other suitable device and may vary in size, shape, performance, functionality, and price. Furthermore, a device may include processing resources for executing machine-executable code, such as a central processing unit (CPU) or a programmable logic array (PLA), as well as one or more computer-readable media for storing machine-executable code, such as software or data.

As used herein, the term “Organization” means any company that has a need for human resources and places a request on the network for a task or a role it would like to see fulfilled, along with a set of qualifications for that job or role.

As used herein, the term “node” shall mean any device that is connected to the network.

As used herein, the term “Request for Personnel” or “Request” shall mean the entry made by the Organization onto the network to find Agents for open positions. A Request may include information such as a description of the type of work to be completed, the necessary skills, any required courses, pay requirements, and any other requirements specific to the open position.

As used herein, the term “Resource Definition” shall mean the entry made by the Agent onto the network in order to make itself available for open positions listed by an Organization as part of a Request for Personnel. The Resource Definition may include a unique identifier, a list of skills and verifications of courses passed, availability and schedule, rate and the type of customer service experience held.

As used herein, the term “transaction” shall mean an action or a process that includes one or more database accesses that modify the state of the blockchain distributed database, such as writing and/or updating of data. In the current embodiment of the present platform, transaction is used to refer both to the action itself and to a definition of the transaction that may be a collection of entities needed for performing the action, such as statements, variables and/or parameters. Accordingly, the term “storing a transaction” may refer to storing a log of the action performed (e.g., transaction involving writing/updating of data) and/or to storing the definition of the transaction. As such, when a node “sends a transaction” to the blockchain distributed database, it may access the database in accordance to the action specific in the transaction (e.g., it may write data and/or run a program stored in the blockchain).

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be also understood to refer to functional equivalents of such structures. The present invention will now be described in detail with reference to embodiments thereof as illustrated in the accompanying drawings. While reference is made to cellular phones, the present invention is applicable to other mobile devices such as e-readers, tablets, and the like.

Whilst the figures may show a single server with modules at times, the network may be decentralized, and thus, each node within the network functions as an independent system contributing to a pool of computing resources shown in the module.

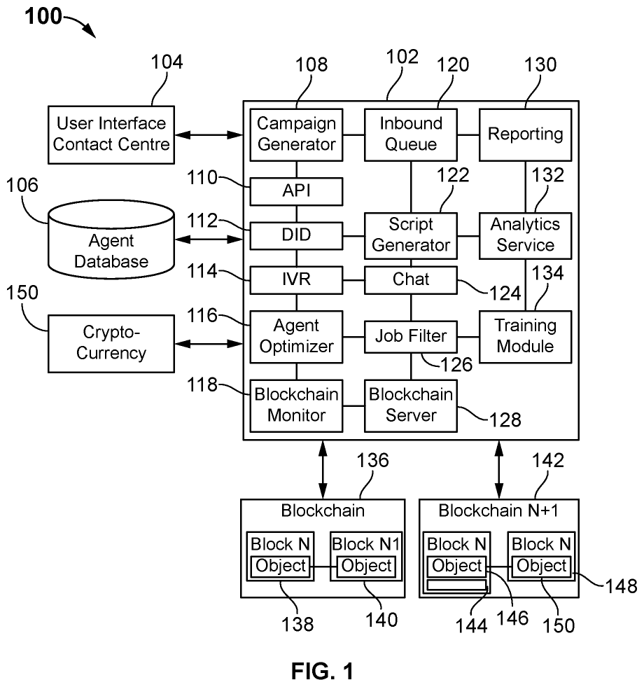

Referring now to FIG. 1 a system diagram for a decentralized network based upon a blockchain used by an organization to build campaigns and to locate and hire agents according to an embodiment of the present disclosure is shown generally at 100. As shown, the system comprises resource server 102 in communication with organization user interface 104, an agent database 106, a first blockchain 136, and a second blockchain 142. In operation, the system creates, deploys, and manages the blockchains 136 and 142 for issuing smart contracts between respective parties, namely, an organization to an agent and vice versa, or a first organization to a second organization for leasing an agent during the downtime of the first agent. The system also utilizes cryptocurrency 150 to manage payment faculties between parties (organizations and agents).

Still with reference to FIG. 1, the resource server 102 comprises various modules. In this embodiment, the resource server 102 comprises campaign generator 108, API 110, direct inward dial (DID) 112, and interactive voice response (IVR) 114, and inbound queue 120, script generator 122, and chat module 124. The campaign generator 108 is configured to receive a plurality of inputs from the organization, and also receive inputs in an automated fashion from the script generator 122, which is in communication with data center 154. The inputs from the organization may be, including but not limited to, a request for agents, a number of agents, and length of time agents are needed for the organization. The input may also comprise whether the organization wants to lease agents from another (or second) organization, or if the organization requires agents from the agent pool who are “freelancing”, meaning not concurrently hired by another organization. The inputs from the data center or database 154 comprise a previous staffing requirement, industry trends, and another organization staffing requirement. The campaign generator 108 is further configured to utilize only the inputs from the data center, and make suggestions to the organizations for agent hiring, timing, and costs. Further, the campaign generator 108 is configured to automatically alert the organizations when a second organization has agents that are on downtime and can be leased to the first organization to fill workforce needs. In this way, the campaign generator is in communication with the workforce management module 152 to forecast needs for organizations, and then deploy those needs via the blockchains 136 and 142.

The direct inward dial (DID) 112 is configured to operate as private branch exchange (PBX) system. The module 112 provides service for multiple telephone numbers over one or more analog or digital physical circuits to the PBX and transmits the dialed telephone number to the PBX so that a PBX extension is directly accessible for an outside caller, possibly by-passing an auto-attendant. In this way, the system allows for organizations that are call centers to utilize a mass-number of agents all over the globe to perform their call center services. The IVR 114 is configured to allow organizations to record customized greetings, messages and prompts so that when customers call your company, they will have a more personalized experience. The IVR 114 is further configured to collect information about customers and store them in the data center 154. The IVR 114 further transfers calls to the most appropriate agent or department depending on their IVR input. When calls are directed to agents using technology, the probability that the caller will be transferred to the wrong agent or department will be significantly reduced. Further, the IVR 114 works with the campaign generator 108 to prioritize calls based on value IVRs allow you to prioritize calls based on the caller's value. When a high-value customer calls, the IVR 114 will route them to the agent who is most qualified to meet their needs.

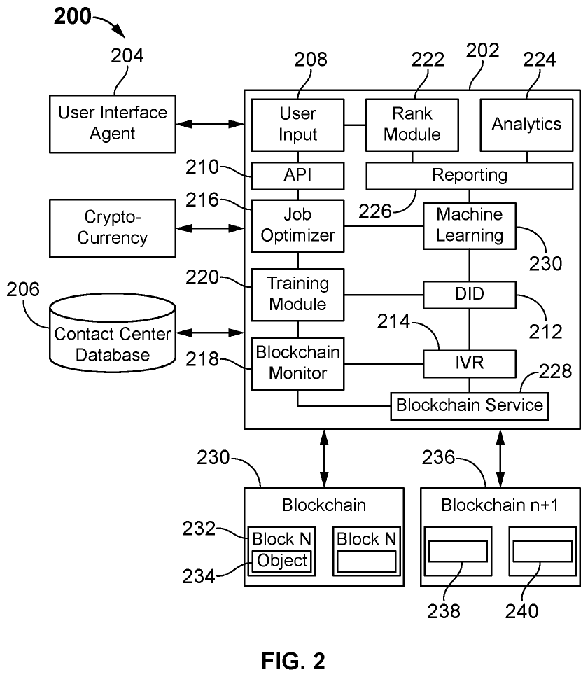

The inbound que 120 is configured to receive and route data, such as calls from customers to the appropriate agents based on organizational standards and requirements. The chat module 124 provides organizations (and agents with reference to FIG. 2) the ability to chat online with customers.

Still with reference to FIG. 1, the resource server further comprises agent optimizer 116, job filter 126, reporting module 130, analytics server 132, training module 134, and workforce management API 152. The agent optimizer 116 and job filter 116 are in communication with the campaign generator 108 and function with the generator 108 to filter out agents from a pool of agents based on a plurality of predetermined factors from the inputs of the organization and the data center 154. After the agent optimizer filters the agents based on the criteria, the job filter 126 utilizes those filtered agents to match them with appropriate positions in organizations. The training module 134 is in further communication with the agent optimizer and job filter and receives inputs as to which agents have been trained for the position. The training module 134 houses the information and pairs the information on training in the agent database 106 and is able to pull information from the agent database 106. All of the information is then pooled and used by workforce management API 152 to place agents with organizations or lease agents from one organization to another. The reporting module 130 and analytics server 132 are configured to gather subsequent information on the client side, for example, number of agents hired, resources utilized, jobs performed by the agent (or calls made) and the dates and length of agency or employment. This data can be viewed by the UI 104.

The resources server 102 is in communication with a distributed ledger (e.g., blockchain) 136 or a plurality of blockchains 142. In operation, the blockchains 136 and 142 are configured to govern the contractual relationships between parties and utilize crypto currency module 150 to provide pay transactions for the labor. The blockchains comprises blockchain object 138 and 140 on a first blockchain 138 and blockchain objects 146 and 150 on the second blockchain 142. The first blockchain object and the second blockchain object may be collectively called blockchain objects. The blockchains may be created by the system 100 and may be deployed by the system. The system 100 may also facilitate and control interactions with the first blockchain object 138, the second blockchain object 146 or both by a user or another system attempting to interact with the blockchain object 138 and 146. For example, the blockchain object 138 may be accessible only to an organization, while the blockchain object 146 may be accessible to an agent. The system 100 may use the blockchain monitor 118 and the blockchain server 128 to synchronize the blockchain objects for use by the organizations and agents.

In operation, the block chains 138 and 142 record all contracts that have been filled or open contracts that need to be filed. Once the contacts are filed, that is an organization hires an agent or leases an agent from an organization, the block chain records the transaction so the cryptocurrency module 150 can issue payment.

Referring now to FIG. 2 a system diagram for a decentralized network based upon a blockchain used by an agent to procure a position with an organization according to an embodiment of the present disclosure is shown generally at 200. As shown, the system comprises second (agent) resource server 202 in communication with agent user interface 204, an organization database 206, an agent first blockchain 230, and a second agent blockchain 236. In operation, the system manages the blockchains 230 and 236 for issuing smart contracts between respective parties, namely, the agent and the organization. The system also utilizes agent cryptocurrency module 250 to manage payment faculties between parties (organizations and agents).

The second resource server 202 comprises various modules. In this embodiment, the resource server 202 comprises user input module 208, API 210, direct inward dial (DID) 212, and interactive voice response (IVR) 214. The user input 208 is configured to receive a plurality of inputs from the user, and also receive inputs in an automated fashion from organization database 206 and function together with the job optimizer 216. The job optimizer 216 functions together with the machine learning module 230 to place the agent with an organization of a pool of organizations based on a plurality of inputs and historical data (e.g., the agents' previous positions with organizations on the system). A training module 220 is in further communication with the job optimizer and receives inputs as to which agents have been trained for the position. The training module 220 allows the agent to login and perform training tasks which are logged in the rank module 222. This allows agents that are most trained to improve their rank based on the training and also train for certain organizations based on the specialties required. The analyzing module 224 pools agent information and works with API 210 to place agents with organizations based on need.

Still referring to FIG. 2, the agent resource server 202 further comprises agent inward dial (DID) 212 and is configured to operate as private branch exchange (PBX) system similar to that described in relation to FIG. 1. An IVR 214 is configured to allow agents to transfer calls as needed. The agent resource server 202 further comprises analyzer 224 and reporting module 228. The reporting module 228 and analyzer 224 are configured to gather subsequent information on the agent side, for example, number of jobs, resources utilized, and the dates and length of agency or employment. This data can be viewed by the UI 204.

The agent resources server 202 is in communication with agent distributed ledger (e.g., blockchain) 230 or a plurality of agent blockchains 236. In operation, the blockchains 230 and 236 are configured to govern the contractual relationships between parties and utilize crypto currency module 250 to provide pay transactions for the agent similar to that of FIG. 1 but provide redundancy so that there are logs on both the organizational side and the agent side. The blockchains comprises blockchain object 238, and 240 on a first blockchain 230 and blockchain object 238 and 240 on the second blockchain 236. Like in FIG. 1, the first blockchain object and the second blockchain object may be collectively called blockchain objects.

In operation, the block chains 232 and 236 record all openings for organization and open contracts that need to be filed. Once the contacts are filed, that is an agent being hired, the block chain records the transaction so the cryptocurrency module can issue payment.

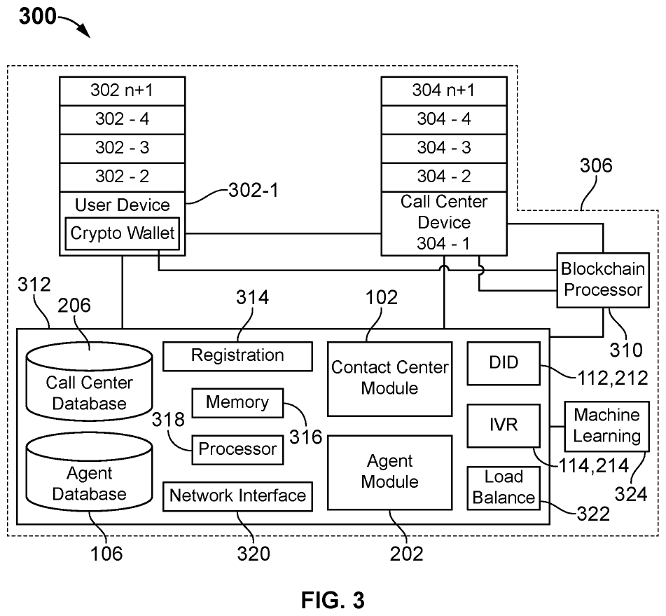

Referring now to FIG. 3, a networked system block diagram for a decentralized network based upon a blockchain used by an organization and an agent according to an embodiment is shown. The network is shown as a network overlay 306 (e.g., decentralized network). The system 300, in this embodiment, comprises a plurality of user devices 302-1, 302-2, 302-3, 302-4, and 302n+1 and organizational devices 304-1, 304-2, 304-3, 304-4 and 304n+1. The devices, in embodiments, are smart devices with UIs. The user devices 302 comprise a cryptocurrency wallet 326 for collection of funds for labor. The call center device 304 and the user device 302 are in communication with a blockchain processor (ledger) 310 and a node 312. Node 312 may be a server that may exist on multiple devices (e.g., other nodes) instead of relying on a single central server. Each of these separate devices interact independently with other nodes. As a result, even if one of the master nodes crashes or is compromised, the other servers can continue providing data access to users, and the overall network will continue to operate with limited or zero disruption. The node 312 comprises or is in communication with call center database 206 and agent data base 106. A registration module 314 is configured to allow both users and organizations the ability to sign up and log in the system, while also storing information such as crypto wallet number and other variables. A memory 316, processor 318 and network interface 320 are provided for communication protocols and the like. The mode 312 further comprise contact center module 102 and agent module 202, DID 112/212 and IVR 114/214 are provided having the functionality described with relation to FIG. 1 and FIG. 2. A load balance 322 is provided to not only balance load on a single node but is further configured to balance traffic amongst nodes based on available resources.

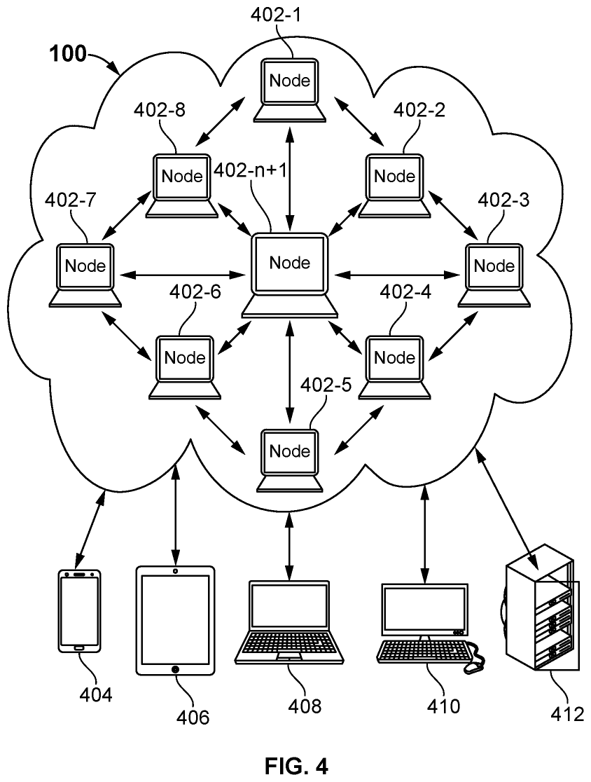

With reference now to FIG. 4, an embodiment of a distributed peer-to-peer network in accordance with one embodiment of the present platform, is shown generally at 400. The peer-to-peer network comprises a plurality of nodes 402-1 through 402-n (which may be referred to herein individually or collectively as 402-n) that may be implemented by a plurality of devices. Overall, the peer-to-peer network 400 represents a computer environment for operating a decentralized frame that maintains a distributed data structure, which in our current embodiment is a blockchain distributed database. The blockchain distributed database may support various transactions, such as distributing computation tasks from one or more systems to one or more other systems, supporting cryptocurrency and messaging, among other functions.

One or more devices, such as a mobile phone 404, portable table 406, laptop 408, personal computer 440 or server 442, may be configured to connect to the distributed peer-to-peer network 402 to perform various transactions, in accordance with one embodiment of the present platform. In optional embodiments, the informational handling systems may be full nodes of the peer-to-peer network 400 in which they perform mining processes, or they may be watching nodes that perform limited functions, embodiments of which are described herein.

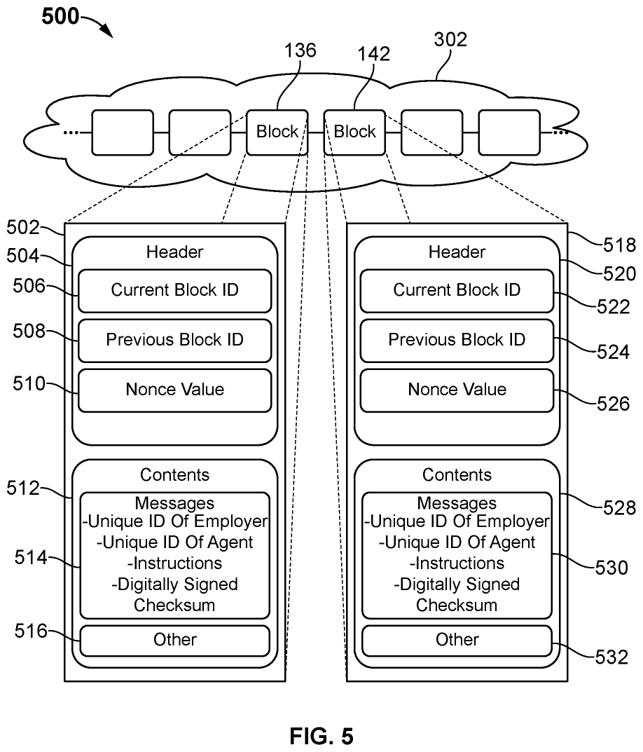

Referring now to FIG. 5, a diagram depicting a blockchain distributed database maintained by nodes in a peer-to-peer network 100 in accordance with one embodiment of the present platform, is presented generally at 500. Using a blockchain to communicate information messages has several benefits. First, messages can be sent to or from a device, multiple devices, or from a combination thereof. Second, it does not rely on centralized authority. Third, once a message is added to the blockchain, it cannot be altered or removed. Fourth, it is decentralized so it is difficult, if not impossible, to block access to it. Finally, a blockchain also allows for the automatic execution of transactions, such as escrow functions, as part of maintaining the blockchain.

Still referring to FIG. 5, the blockchain 500 may be used to receive messages from or send messages to a device or devices using the blockchain in the current embodiment. Consider, by way of example, a message in block 505 of the blockchain 500. In the current embodiment, the block 505 may have a header 504, which will comprise a block ID 506 for that block, a block ID 508 for the previous block, and a nonce value 510, which allows for the authentication of the block 505. In the current embodiment, this information is used to link the block 505 into the blockchain 500.

Still referring to FIG. 5, the contents 515 may comprise one or more messages 514 as well as other data 516. In the current embodiment, the messages 214 may contain a unique identifier of both the sender and recipient of a message—in this case, this would be for the Organization and Agent, and may be used for one or more reasons. For example, the unique identifier allows the receiving device to identify who sent the message. In the current embodiment, this would allow the Organization to identify which Agent uploaded a Resource Definition; in the alternative, and in this current embodiment, the unique identifier would allow the Agent to identify which Organization submitted a Request for Personnel. Furthermore, the unique identifier also provides a way by which a device can address a response to a sender, if desired. The unique identifier may also be used or linked to an account to pay for fees associated with using the blockchain as a communication channel, to perform computations, pay for transactions, or other actions. In the current embodiment, this would include transactions such as paying for courses offered through the blockchain and paying Agents hired by an Organization.

Still referring to FIG. 5, the message 514 may include instructions, such as configuration data, management data, and/or instruction-related data, for the device. In optional embodiments, this data may be a link to the configuration data, management data, and/or instruction-related data, or may be the data itself, which may be in the form of an executable program, a container, or a link to data. A link to a program (or container) may comprise a unique identifier or an address to a program in the blockchain, may be a link to an application or container available outside the blockchain, or a combination thereof.

Still referring to FIG. 5, the message 514 may include a way or ways for authenticating the message 514. For example, the message 514 may include a digitally signed checksum to verify the message, such that the sender of a message may digitally sign a checksum or hash of the message using his or her private key. A receiving device can verify the integrity of the data by verifying the checksum using the sender's key. Those having the skill in the art shall recognize that other methods for verifying the data integrity may also be employed.

Still referring to FIG. 5, it shall also be noted that in the current embodiment of the present platform, the blockchain 500 may be used to send messages regarding confirmation, configuration status, results information, or other data. For example, a message in block 518 of the block 500 may contain a header 520 and contents 528. Like the header 504 discussed with respect to block 502, the header 520 of block 518 comprises a current block ID 522, a previous block ID 524 and a nonce value 526 used to authenticate the block 518. Similarly, to the message in block 502, the contents 528 may comprise one or more messages 514 and may also comprise other data 530. In the current embodiment, the message 514 may comprise a unique identifier of the recipient of the message, a unique identifier of the submitted of the message, data (e.g., confirmation of receipt of the message, status, results information, or other data) or a link to the data, as well as a digitally signed message checksum to verify the message.

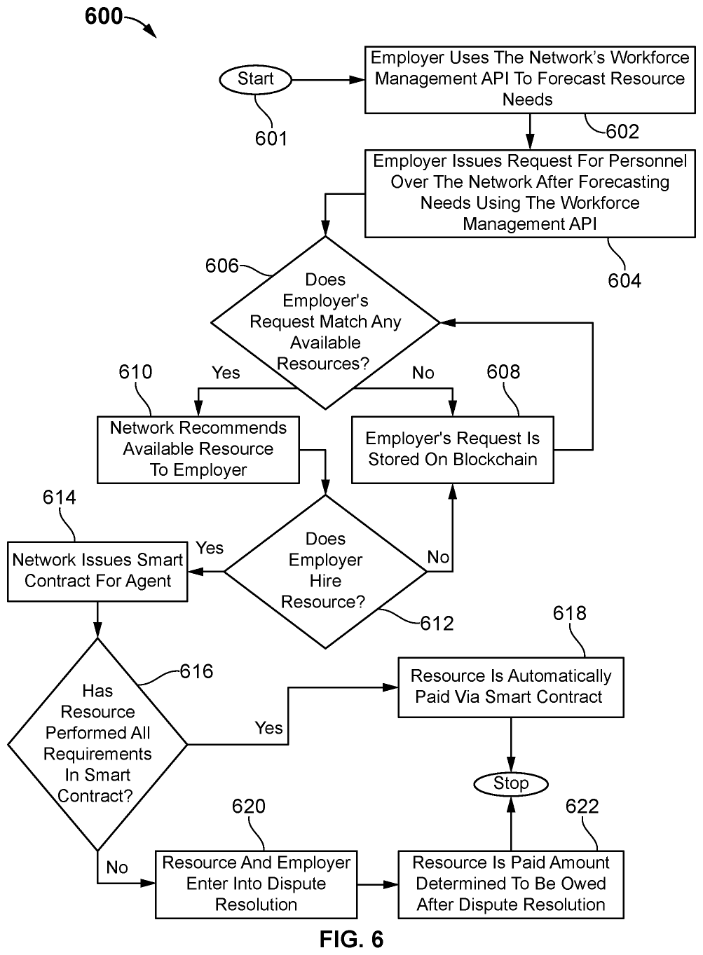

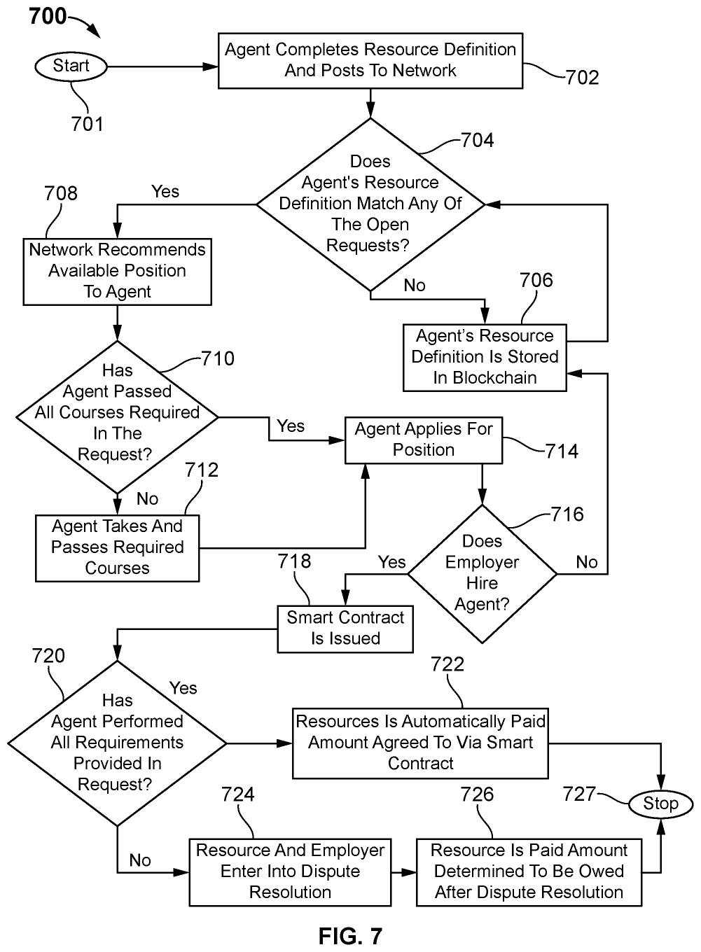

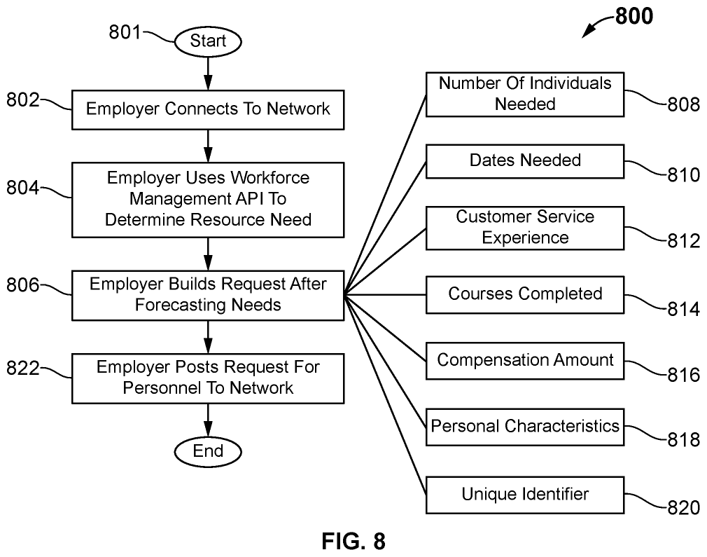

Referring now to FIG. 6, a diagram depicting a method through which an Organization solicits, hires and pays for Agents using a blockchain distributed database in accordance with one embodiment of the current platform, is shown generally at 600. At step 601, the organization logs inn the decentralized network. At step 602, the Organization uses the network's Workforce Management API to forecast resource needs. In optional embodiments, the network's Workforce Management API may automatically suggest projected resource needs to the Organization based off of various data and datasets collected, including but not limited to, previous staffing needs, current industry trends and competitor needs. Once the system has determined the organizations personnel needs using the Workforce Management API, then in step 604 the Organization issues a Request for Personnel over the network using a device. The process through with an Organization creates a Request for Personnel (Request) is further discussed herein about FIG. 7 and FIG. 8. At step 606 the device may call a function located within the blockchain to check whether the Organization's Request matches the Resource Definition of any available Agent. If there are no matches, then in step 608 the Organization's Request is stored on the blockchain and will continue to be available until there is a matching Agent. If there is a match, however, then in step 610 the network will recommend the available Agent to the Organization. At this point, the Organization then determines whether to hire the Agent in step 612. If the Organization does not hire the Agent, then the Organization's Request will be stored as part of the blockchain in step 606. If the Organization does hire the Agent, then a smart contract will be issued for the Agent in Step 614. It is important to note that the Agent may come from a database of available agents or leased from other organizations depending upon that organizations workload.

Still referring to FIG. 6, once a smart contract has been issued, then in step 616 a function will determine whether the Agent has performed all the requirements included in the smart contract. If the checking function determines that the Agent has performed all requirements in the smart contract, then the Agent will be automatically paid in step 618. If, however, the checking function determines that the Agent has not performed all the requirements in the smart contract, then in step 620 the Organization and Agent will enter the dispute resolution procedures. Once the Organization and Agent settle the dispute, then in step 622 the Agent is paid the amount agreed to after the dispute resolution.

Referring now to FIG. 7, a diagram depicting a method through which an Agent finds employment, is trained for such employment and receives payment for performing the job using a blockchain distributed database in accordance with one embodiment of the current platform, is shown generally at 700. At step 701, the agent logs in to the network. At step 702, the Agent completes a Resource Definition and posts it to the network. In optional embodiments, the Agents who are working at existing call centers may have their Resource Definition automatically completed and uploaded to the network. At step 704, the device may call a function located within the blockchain to determine whether the Agent's Resource Definition matches any of the Requests issued by an Organization. If the function determines that there are no matching Requests, then in step 706 the Resource Definition is stored in the blockchain and will be checked again in the future when an Organization issues another Request to determine if the Agent's Resource Definition matches. If the function determines that there is a match, then at step 708 the network recommends the available Request to the Agent.

Still referring to FIG. 7, if the network determines the Agent's Resource Definition matches an Organization's Request, then in step 710 the device will execute a function to determine whether the Agent has passed all the required courses. If the function determines that the Agent has not passed all the required courses, then in step 712 the Agent will be required to take and pass the courses before being allowed to apply for the position in step 714. If the function determines that the Agent has passed all the required courses, then the Agent will be allowed to apply for the position in step 714. Once the Agent applies for the position in step 714, the Organization will have the option to hire the Agent in step 716. If the Organization elects to not hire the individual, then the Agent's Resource Definition will be stored in the blockchain 706 and examined against future Requests issued into the network to determine if there is a match. If the Organization does hire the Agent, then a smart contract will be issued for the Agent in Step 418.

Still referring to FIG. 7, once a smart contract has been issued, then in step 720 a function will determine whether the Agent has performed all the requirements included in the smart contract. If the checking function determines that the Agent has performed all requirements in the smart contract, then the Agent will be automatically paid in step 722. If, however, the checking function determines that the Agent has not performed all the requirements in the smart contract, then in step 724 the Organization and Resource will enter the dispute resolution procedures. Once the Organization and Agent settle the dispute, then in step 726 the Agent is paid the amount agreed to after the dispute resolution.

Referring now to FIG. 8, a diagram depicting a method through which an Organization builds and issues a Request using a blockchain distributed database in accordance with one embodiment of the current platform, is shown generally at 800. At step 801, the organization logs in to the network. At step 802, the Organization connects to the blockchain distributed database via a device. At step 804, the Organization then forecasts its resource needs by using the Workforce Management API. In optional embodiments, the network's Workforce Management API may automatically suggest projected resource needs to the Organization based off of various pieces of data collected, including but not limited to, previous staffing needs, current industry trends and competitor needs. Thereafter, in step 806 the Organization then builds its Request by inputting certain minimum qualifications that will be analyzed through a function to determine if any Agents meet such a Request. In the current embodiment, those qualifications may include the dates needed 810, prior customer service experience 812, courses completed on the network 814, compensation amount 816 and personal characteristics 818. In optional embodiments, other qualifications may be included such as language preferences. In addition, each Request will also include the total number of resources needed 808 as well as a unique identifier 820. Once the Organization builds the Request, then in step 822 it is posted to the network at which point it becomes accessible to the Agents.

In embodiments of the present platform for offer courses 814, because the platform is decentralized, the platform shares knowledge in a peer-to-peer manner. Consequently, in operation, any users may design a course and start offering the course to others on the network for a small transaction fee (or free in some embodiments). Users (e.g., professors, corporate trainers) are rewarded in tokens for offering a course via “University Platform” every time someone attends their course.

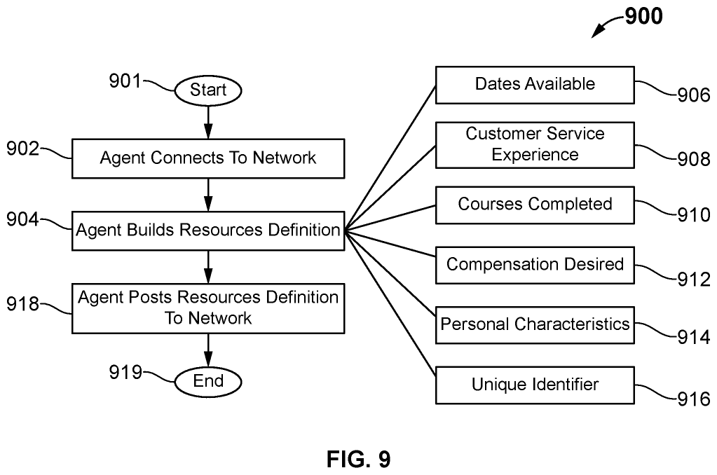

Referring now to FIG. 9, a block diagram depicting a hybrid system/method diagram through which an Agent builds and issues a Resource Definition using a blockchain distributed database in accordance with one embodiment of the current platform, is shown generally at 900. At step 901, the agent logs in to the network. At step 902, the Agent connects to the blockchain distributed database via a device. At step 904, the Agent then builds its Resource Definition by inputting certain skills, requirements and other pertinent information that will be analyzed through a function to determine if an Organization has an open Request that matches with the Agent's Resource Definition. In the current embodiment, the information inputted may include the dates available 906, prior customer service experience 908, courses completed on the network 910, compensation desired 912 and personal characteristics 914. In optional embodiments, other qualifications may be included such as languages spoken. In addition, each Resource Definition will also include a unique identifier 916. Once the Agent builds the Resource Definition, then in step 918 it is posted to the network at which point it becomes accessible to the Agents. In optional embodiments, Agents who are working at existing call centers may have their Resource Definition automatically completed and uploaded to the network.

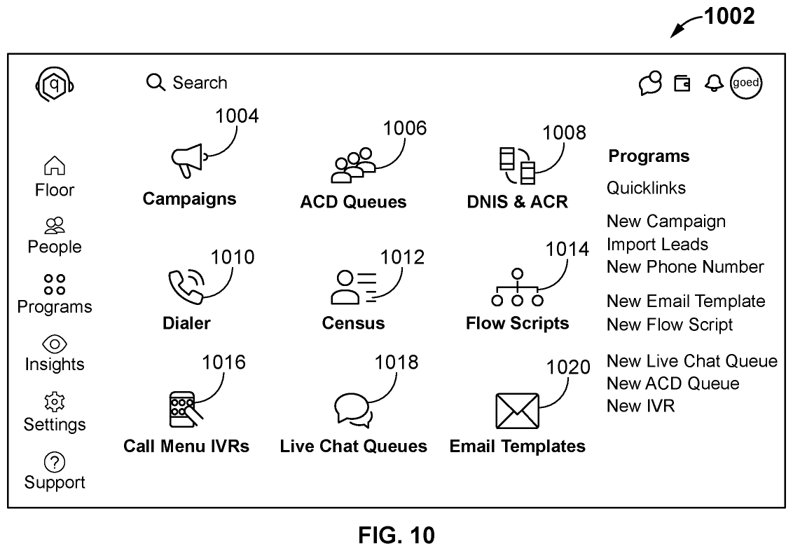

Referring now to FIG. 10, an exemplary user interface for an organization in accordance with one embodiment of the present invention is shown at 1002. In this UI, the organization can generate a campaign using option (object) 1004, utilize automatic call dialer (ACD) queue object 1006, DNS account to collector ratio (ACR) object 1008 dial using object 1010, take census object 1012, use flow scripts object 1014, make calls object 1016, live chat object 1018, and email 1020.

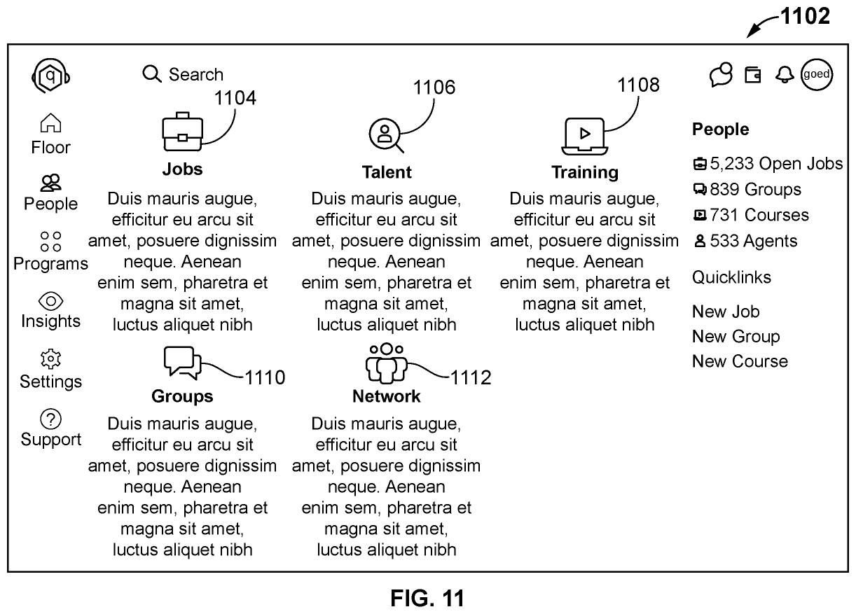

Referring now to FIG. 11, an exemplary user interface for an agent in accordance with one embodiment of the present invention is shown at 1102. In this UI, agent can search jobs object 1104, show talents (upload experience) object 1106, utilize training object 1108, group with another agent's object 1110, and network object 1112.

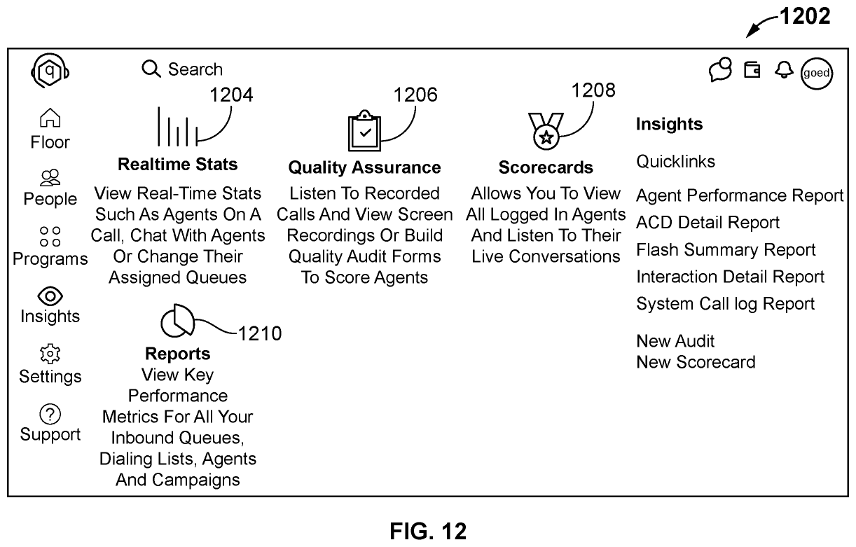

FIG. 12 illustrates another exemplary user interface for an organization in accordance with one embodiment of the present invention is shown generally at 1202. In this UI, the organization can utilize analytics, for example real-time stats object 1204, quality assurance 1206, scorecard object 1208 and reporting object 1210.

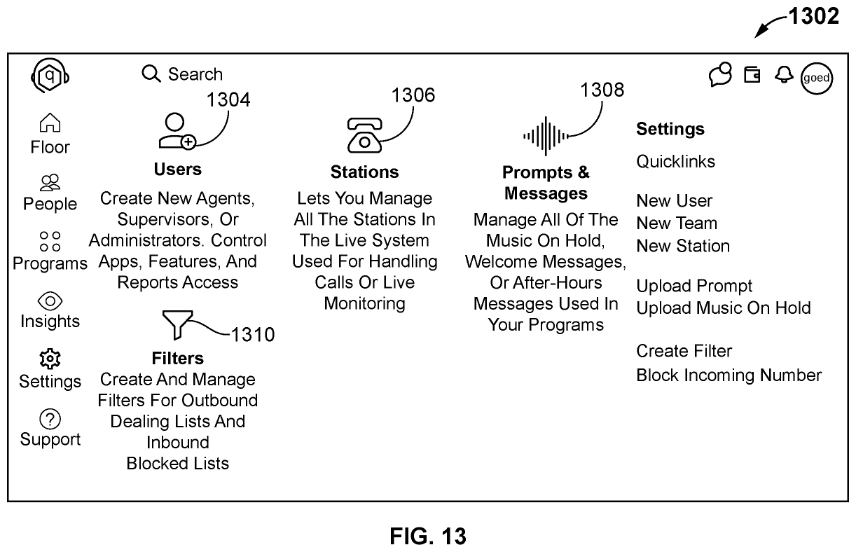

FIG. 13 illustrates another exemplary user interface for an organization in accordance with one embodiment of the present invention is shown at 1302. In this embodiment, the organization can view user object 1304, stations object 1306, prompt object 1308, and filter object 1310. Filters allow the organization to filter agents based on optimize criterion.

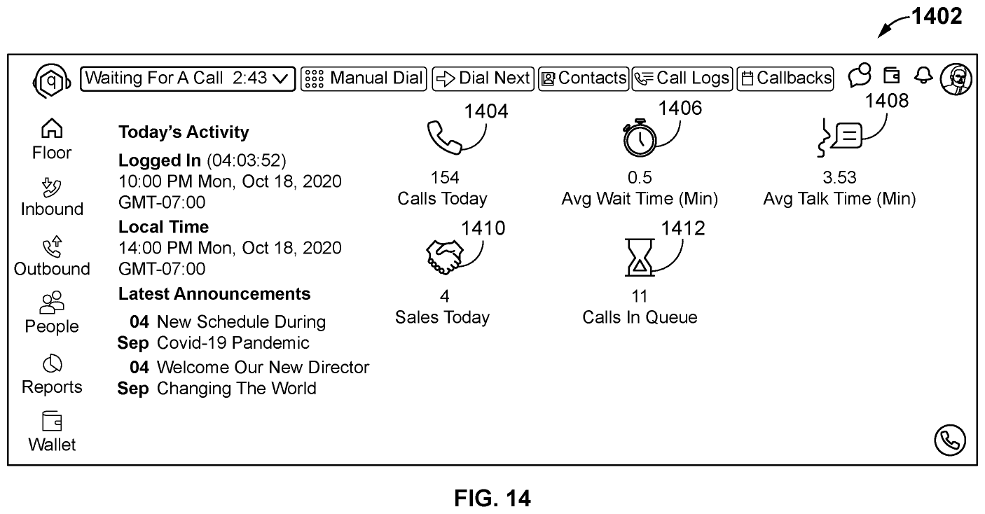

FIG. 14 illustrates another exemplary user interface for an agent in accordance with one embodiment of the present invention at 1402. The UI allows the organization to via call object 1404, average time of call object 1406, and average time for call 1408, sales made 1410 and calls in queue 1412.

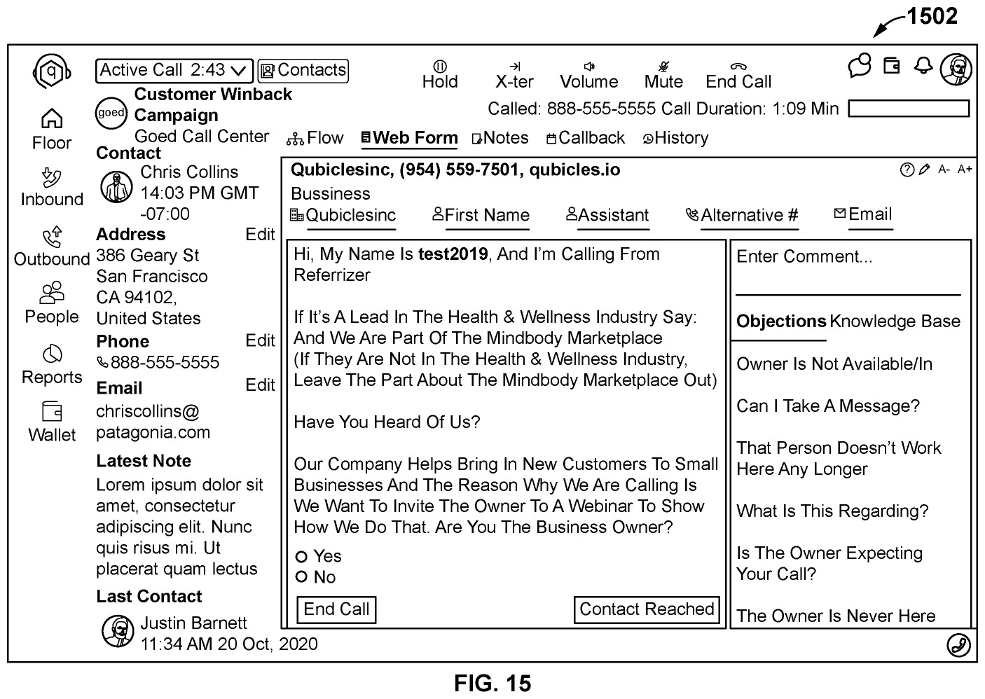

FIG. 15 illustrates another exemplary user interface for agent to chat with a customer accordance with one embodiment of the present invention at 1502.

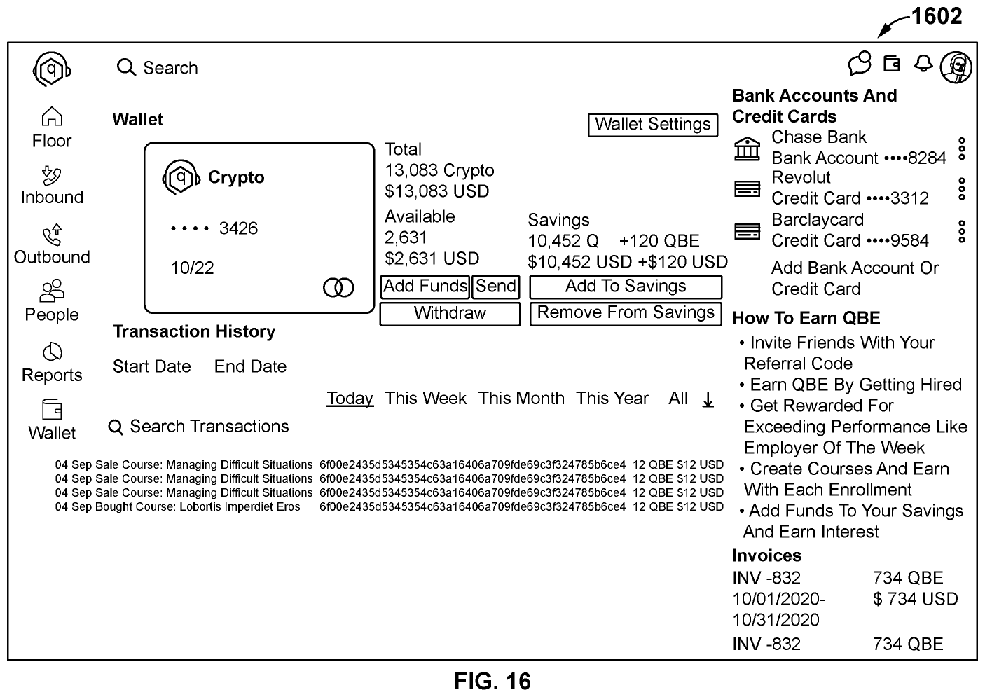

FIG. 16 illustrates another exemplary user interface for payments in accordance with one embodiment of the present invention at 1602.

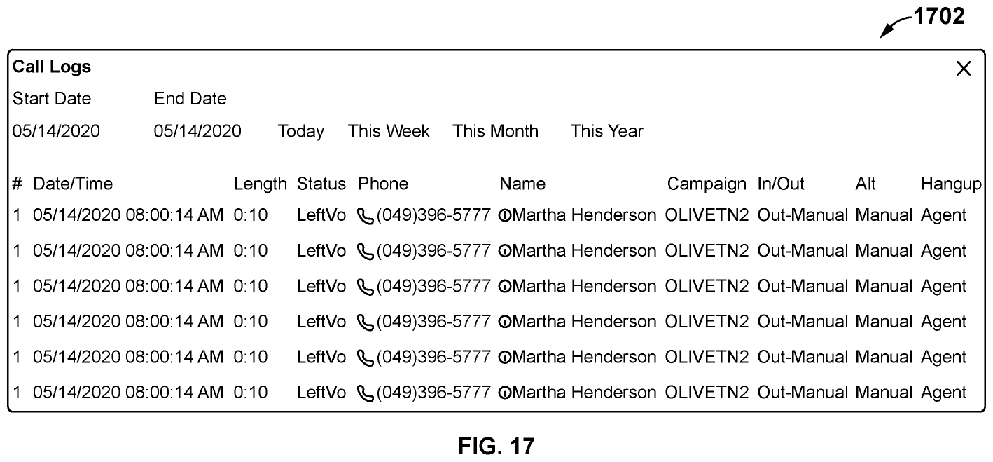

FIG. 17 illustrates another exemplary user interface for a call log in accordance with one embodiment of the present invention at 1702

In operation, the platform further comprises performance awards for agent performance data (calls handled, average handle time, average talk time, average wrap time, average idle time, total sales, quality audit scores, client specific KPIs met) which are used to reward Agents in tokens for meeting and exceeding goals.

Specific configurations and arrangements of the platform, discussed above regarding the accompanying drawing, are for illustrative purposes only. Other configurations and arrangements that are within the purview of a skilled artisan can be made, used, or sold without departing from the spirit and scope of the platform. For example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures.

While the present platform has been described in connection with what are presently considered to be the most practical and preferred embodiments, it is to be understood that the present platform is not limited to these herein disclosed embodiments. Rather, the present platform is intended to mobile phone the various modifications and equivalent arrangements included within the spirit and scope of the appended claims.

Although specific features of various embodiments of the platform may be shown in some drawings and not in others, this is for convenience only. In accordance with the principles of the platform, the feature(s) of one drawing may be combined with any or all of the features in any of the other drawings. The words “including,” “comprising,” “having,” and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

I claim:

1. A system for managing human resources over a decentralized human resources network, the system comprising:
a plurality of nodes in a decentralized network in communication with one ore more distributed ledgers capable of recoding data ledgers, each node having one or more processors and a memory, the memory being a non-transitory computer-readable medium having executable instructions encoded thereon, such that upon execution of the instructions, one or more nodes in the plurality of nodes perform operations of:
receive a resource definition associated with an agent of a plurality of agents;
receive a request from the organization for a need for at least an agent of the plurality of agents;
store the request on the one or more distributed ledgers;
call a function located within the distributed ledger to ascertain whether the request from the organization matches the resource definition of the at least one agent of the plurality of agents;
if there are no matches, store, on the distributed ledger an open request;
continuously query the function until the request from organization matches one of the resource definitions associated with an agent of the plurality of agents;
if there is a match, notify the agent and the organization;
issue a smart contract to the agent from the organization and store the contract in the distributed ledger.

2. The system of claim 1, wherein one or more nodes in the plurality of nodes further performs operation of:
forecast a human resource need for the organization of a plurality of organizations, wherein the forecast comprises utilizing at least one of a previous staffing requirement, an industry trend, and another of the plurality of organizations staffing requirement

3. The system of claim 3, wherein one or more nodes in the plurality of nodes further performs operations of utilizing machine learning to:
match the resource definition to the function;
forecast the organization human resource needs.

4. The system of claim 2, wherein one node of the plurality of nodes is the another organization, and wherein the smart contract is derived from the from the organization to the another organization.

5. The system of claim 3, wherein one or more nodes in the plurality of nodes further performs operations of:
determine if the agent has performed a requirement of the smart contract;
if the requirement have been met, automatically pay the agent,
if the requirement have not been met, automatically enter dispute resolution.

6. The system of claim 1, wherein one or more nodes in the plurality of nodes further performs operation of, at a first node of the plurality of nodes, automatically send a completed resource definition from an agent to the distributed ledger.

7. The system of claim 1, wherein one or more nodes in the plurality of nodes further performs operation of determine if the agent has passed a course, and if the agent has, store an outcome on the course of the distributed ledger.

8. The system of claim 1, wherein one or more nodes in the plurality of nodes further performs operation of, at a second node of the plurality of nodes, build a campaign comprising the request from the organization.

9. The system of claim 1, wherein one or more nodes in the plurality of nodes further performs operations of, at a second node of the plurality of nodes, receive an input of a minimum agent requirement comprising a qualifications, wherein the qualification comprises at least on of a dates prior customer service experience, courses completed, compensation amount required and personal characteristics and language preference.

10. The system of claim 1, wherein building the resource definition comprises combining an input from the organization and the data from the third node of a plurality of nodes.

11. A computer implemented method for consensus ordering of broadcast messages, the method comprising an act of causing one or more of a plurality of nodes in a network to execute instructions stored on a non-transitory computer readable medium, such that upon execution of the instructions, one or more nodes in the plurality of nodes perform operations of:
receiving a resource definition associated with an agent of a plurality of agents;
receiving a request from the organization for a need for at least an agent of the plurality of agents;
storing the request on the one or more distributed ledgers;
calling a function located within the distributed ledger to ascertain whether the request from the organization matches the resource definition of the at least one agent of the plurality of agents;
if there are no matches, storing, on the distributed ledger an open request;
continuously querying the function until the request from organization matches one of the resource definitions associated with an agent of the plurality of agents;
if there is a match, notifying the agent and the organization;
issuing a smart contract to the agent from the organization and storing the contract in the distributed ledger.

12. The method of claim 11, further comprising forecasting a human resource need for the organization of a plurality of organizations, wherein the forecasting stope comprises utilizing at least one of a previous staffing requirement, an industry trend, and another of the plurality of organizations staffing requirement

13. The method of claim 12, further comprising matching the resource definition to the function and forecasting the organization human resource needs utilizing machine learning.

14. The method of claim 11, wherein one node of the plurality of nodes is the another organization, and wherein the smart contract is derived from the from the organization to the another organization.

15. The method of claim 13, further comprising:
determining if the agent has performed a requirement of the smart contract, and if the requirement have been met, automatically paying the agent and if the requirement have not been met, automatically entering dispute resolution;
automatically send a completed resource definition from an agent to the distributed ledger;
determining if the agent has passed a course, and if the agent has, store an outcome on the course of the distributed ledger and
building a campaign comprising the request from the organization.

16. A system for managing human resources on a decentralized human resources network, the system comprising:
a first client computer system;
a second client computer system;
and a resource server computer system;
wherein both the server computer system are configured to communicate with a distributed blockchain computer system that includes multiple computing nodes, each computing node storing a copy, or a portion thereof, of a blockchain of the distributed blockchain computer system;
wherein the resource server computer system comprises:
a memory configured to store;
a distributed ledger database comprising linked data block, wherein the distributed ledger configured to determine whether there is a match between a request for personnel from an organization, and a resource definition from an agent;
a campaign generator configured to receive a plurality of inputs from the organization, and also receive information from a script generator to request the agent;
wherein the organization is a call center.

17. The system of claim 16, wherein the resource server is in communication with a resource database, and wherein the script generator pulls inputs from resource database and routes the inputs to the campaign generator, wherein the resource inputs from the resource database comprise at least one of a previous staffing requirement, industry trends, and another organization staffing requirement.

18. The system of claim 16, wherein the campaign generator is further configured to automatically alert the organization when a second organization has agents that are on downtime and can be leased to the first organization to fill workforce needs.

19. The system of claim 16, further comprising a direct inward dial (DID) configured to operate as private branch exchange (PBX) system and an IVR configured to allow organizations to record customized greetings and messages.

20. The sytem of claim 16, further comprising:
an inbound que is configured to receive and route data to the appropriate agents of a plurality of agents based on organizational standards and requirements;
an agent optimizer configured to filter out agents from a plurality of agents based on a plurality of predetermined factors from the inputs of the organization;
a training module in further communication with the agent optimizer and configured to receive inputs as to which agents have been trained for the position.
